(19) United States
(12) Patent Application Publication
(10) Pub. No.: US 2007/0048603 A1
(43) Pub. Date: Mar. 1, 2007

(54) Low resistance lithium battery set

(75) Inventors: Jing-Yih Cherng, Tao-Yuan (TW); Hein-Wen Hwang, Tao-Yuan (TW); Jian-Chung Lin, Tao-Yuan (TW)

Correspondence Address: HDSL, 4331 STEVENS BATTLE LANE, FAIRFAX, VA, 22033, US

(73) Assignee: Amita Technologies Inc Ltd.

(21) Appl. No.: 11/211,448

(22) Filed: Aug. 26, 2005

(51) Int. Cl. H01M 6/42; H01M 2/24

(52) U.S. Cl. 429/159; 429/160

(57) ABSTRACT

A low resistance lithium battery set includes a chassis, and lithium batteries. A collector board is disposed in the chassis, which includes many insertion holes for connecting with the electrodes of lithium batteries. The electrodes of the batteries are penetrated through the insertion holes and then folded to connect with each other. The power output of the lithium batteries is then delivered through the contact points of the collector board. The output of the battery set is thus adjustable by changing the connection of battery electrodes. Therefore, the battery set can be used in a variety of electronic devices.

### BACKGROUND OF THE INVENTION

The present invention relates generally to a low resistance lithium battery set, and more particularly to a parallelly connected lithium battery set that is easily adjustable according to the input power structure of an electronic device.

A conventional lithium battery set used, for example, in cellular phone or in personal digital assistant, normally includes a plurality of lithium batteries parallelly or serially connected with each other. The connected batteries are electrically coupled to a special connector by a conducting wire, and packaged by a chassis. The special connector is situated outside of the chassis. Thus, a battery for use in an electronic device is produced.

However, the conventional battery set described above often uses nickel strips to form parallel or serial connections between individual lithium batteries. Therefore, the internal resistance of the battery set becomes unusually high, which is inapplicable to high current discharge. In addition, the conducting wire is easily loosen and rendering poor contact. Moreover, the connector for and the position of the positive and negative electrodes of the conventional battery set are fixed once the battery set is produced. Therefore, each electronic device and the electronic device of different brands require a battery set of a particular connector and a particular output voltage. No generic battery set is available for electronic devices of different brands. This is indeed a waste of resources and an inconvenience of usage.

Accordingly, the inventor of the present invention realized the drawbacks in the conventional art, and developed the present invention that can overcome the drawbacks described above.

### BRIEF SUMMARY OF THE INVENTION

The present invention is to provide a low resistance lithium battery set that can provide different outputs in accordance with the requirement of different electronic devices.

In order to achieve the above and other objectives, the low resistance lithium battery set includes a chassis having a collector board disposed therein, and a plurality of lithium batteries. The collector board includes a plurality of insertion holes for penetrating therethrough the electrodes of lithium batteries. The electrodes of the batteries are then folded to connect with each other. The power output of the lithium batteries is then delivered through the contact points of the collector board.

### BRIEF DESCRIPTION OF THE DRAWINGS

FIG. 1 is an explosive view illustrating a battery set, in accordance with the first embodiment of the present invention.

FIG. 2 is a perspective view illustrating a battery set, in accordance with the first embodiment of the present invention.

FIG. 3 is a sectional view illustrating a battery set, in accordance with the first embodiment of the present invention.

FIG. 4 is a decomposition diagram of a battery set, in accordance with the second embodiment of the present invention.

FIG. 5 to FIG. 8 illustrates the usage of the battery set, in accordance with the second embodiment of the present invention.

FIG. 9 is an explosive view illustrating the battery set, in accordance with the third embodiment of the present invention.

FIG. 10 is an explosive view illustrating the battery set, in accordance with the fourth embodiment of the present invention.

FIG. 11 is an explosive view illustrating the battery set, in accordance with the fifth embodiment of the present invention.

FIG. 12 is an explosive view illustrating the battery set, in accordance with the sixth embodiment of the present invention.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

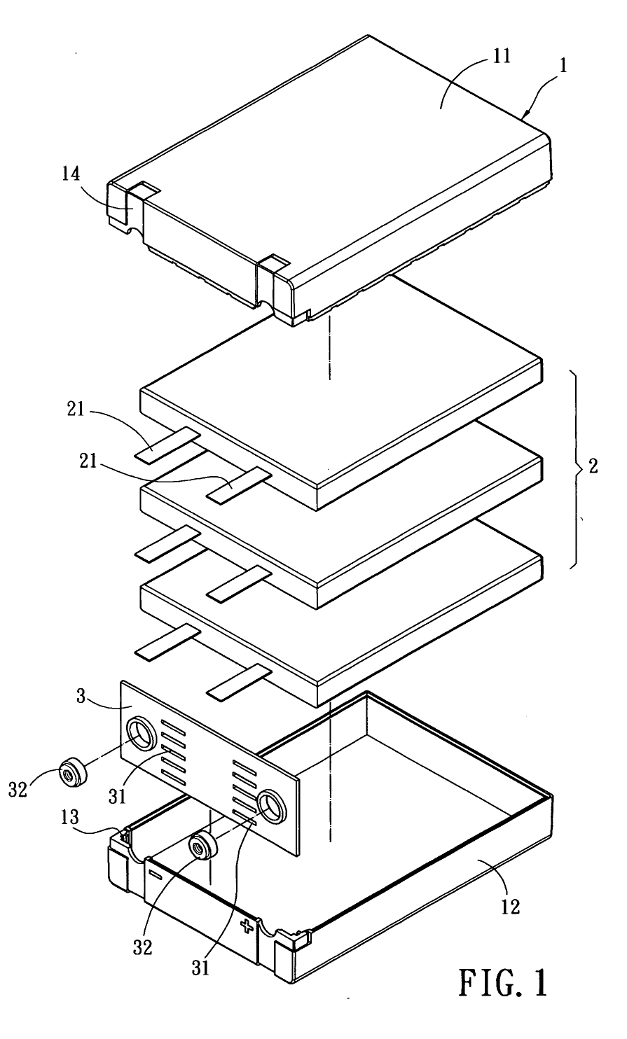

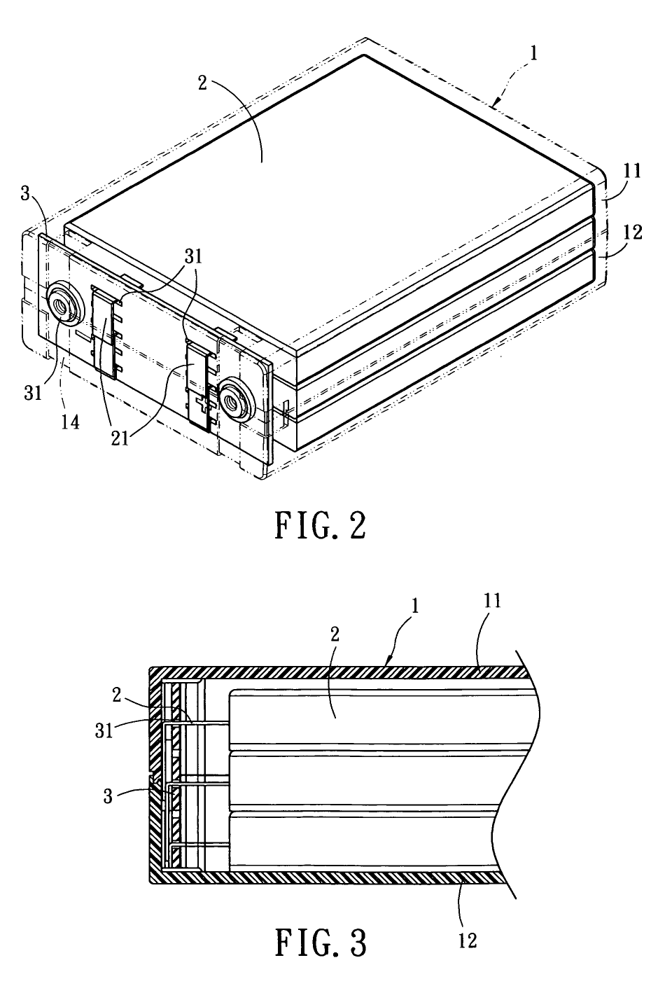

Referring to FIG. 1 and FIG. 2, an explosive view and a perspective view of a battery set in accordance with the first embodiment of the present invention are illustrated. The low resistance lithium battery set of the present invention includes a chassis 1, and a plurality of batteries 2. The output power of the battery set is easily adjustable by changing the connections of the batteries, in accordance with the input power structure of different electronic devices.

The chassis described above includes an upper cover 11 and a lower cover 12. The chassis includes an insertion groove 13, which includes a collector board 3 inserted thereon. The collector board 3 includes a plurality of insertion holes 31, and a contact point 32 that connects with the exterior of the chassis 1.

A plurality of batteries 2 is disposed in the chassis 1. The electrodes 21 of each battery are inserted into the insertion holes 31 of the collector board 3. Each electrode 21 is folded to contact with each other on the collector board 3, thereby forming positive and negative electrodes on the contact points 32.

Referring to FIG. 2 and FIG. 3, an explosive, a perspective view and a sectional view of the present invention are illustrated. When assembling the battery set of the present invention, the electrodes 21 of each battery 2 are penetrated through the insertion holes of the collector board 3, and are folded to contact with each other. The battery 2 is then disposed into the lower cover 12. Meanwhile, the collector board 3 is inserted into the insertion groove 13. The upper cover 11 is then disposed on the lower cover 12. The assembly of battery set is thus completed. The positive and negative electrodes defined by the contact points 32 of the collector board 3 can then be electrically connected to an electronic device (not shown) and supply electrical power to the electronic device.

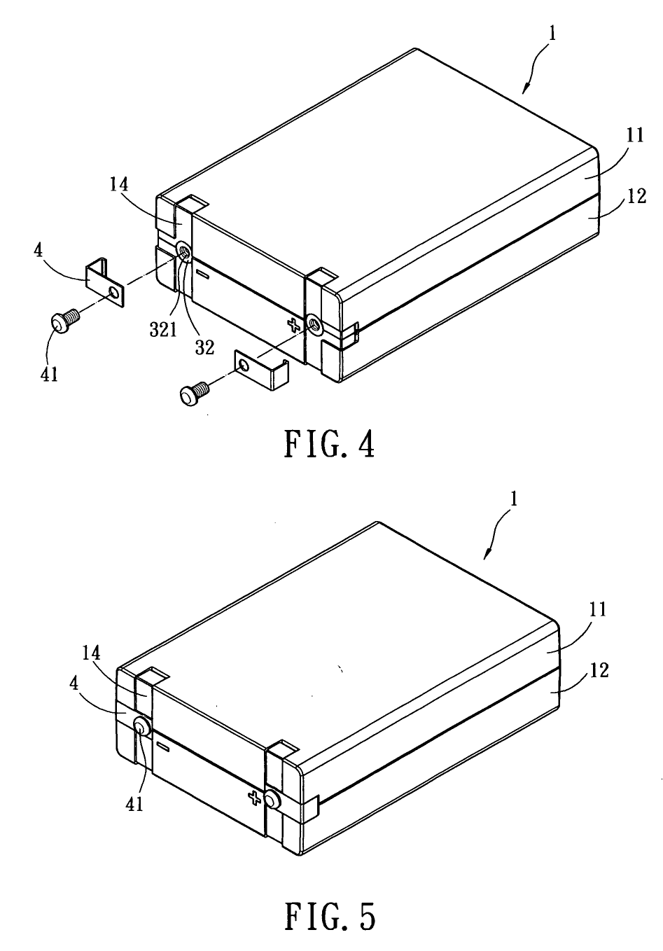

Referring to FIG. 4, a decomposition diagram in accordance with the second embodiment of the present invention is illustrated. As shown, two side surfaces of the chassis 1 include a sagged portion 14, respectively, thus rendering the communicable connection between the contact points 32 and the sagged portions 14. The sagged portion 14 is a concave groove communicably connecting to a plurality of directions. The contact point 32 includes a fastening hole 321. The fastening hole 321 fastens a conducting element 4 to each sagged portion 14 via a fastening element 41. The fastening element 41 and the contact point 32 are electrically connected, while the conducting element 4 is a foldable metallic plate.

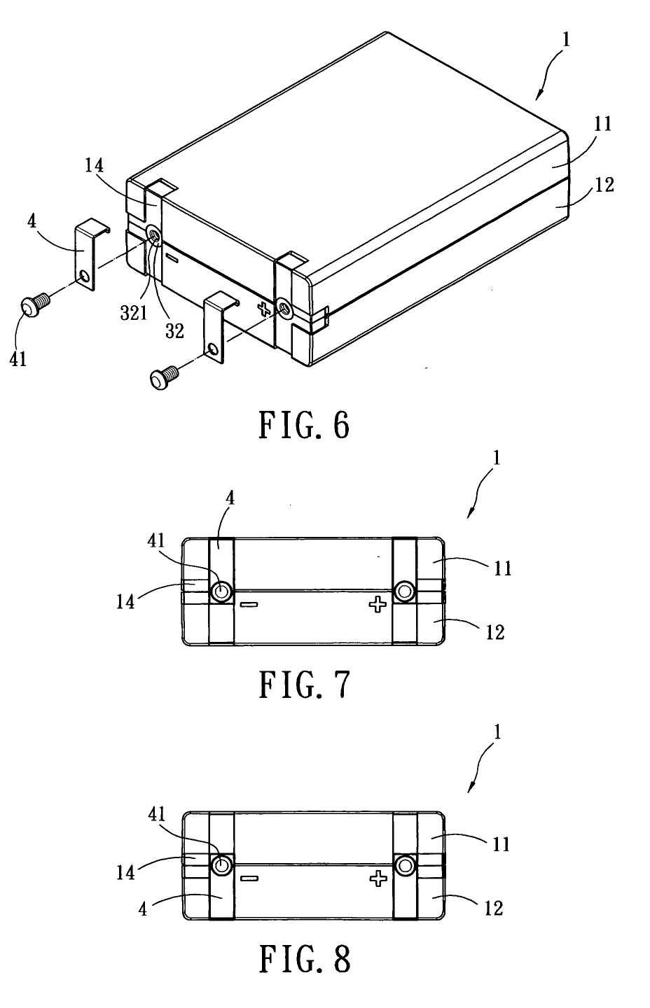

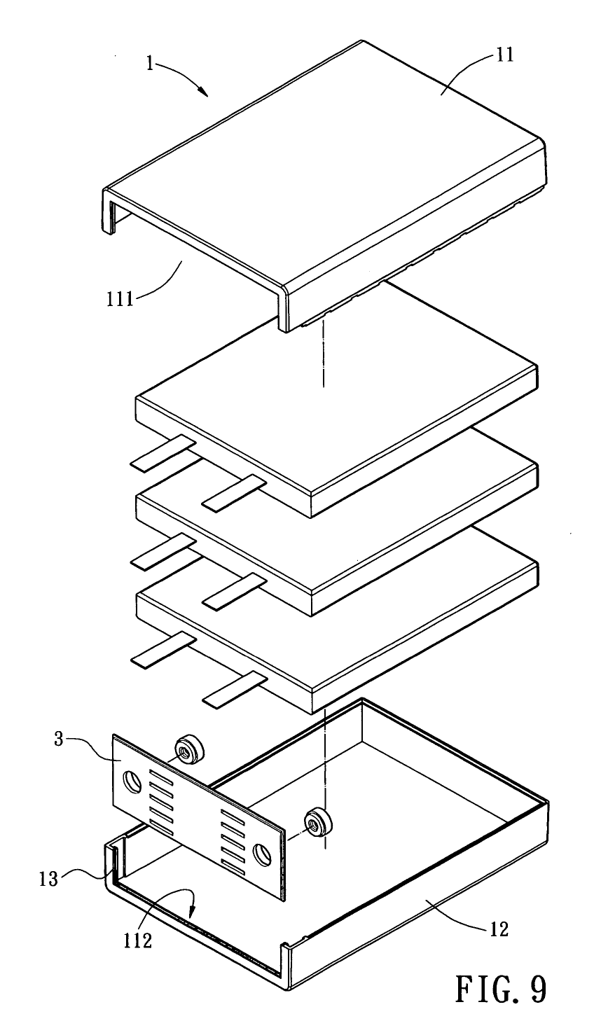

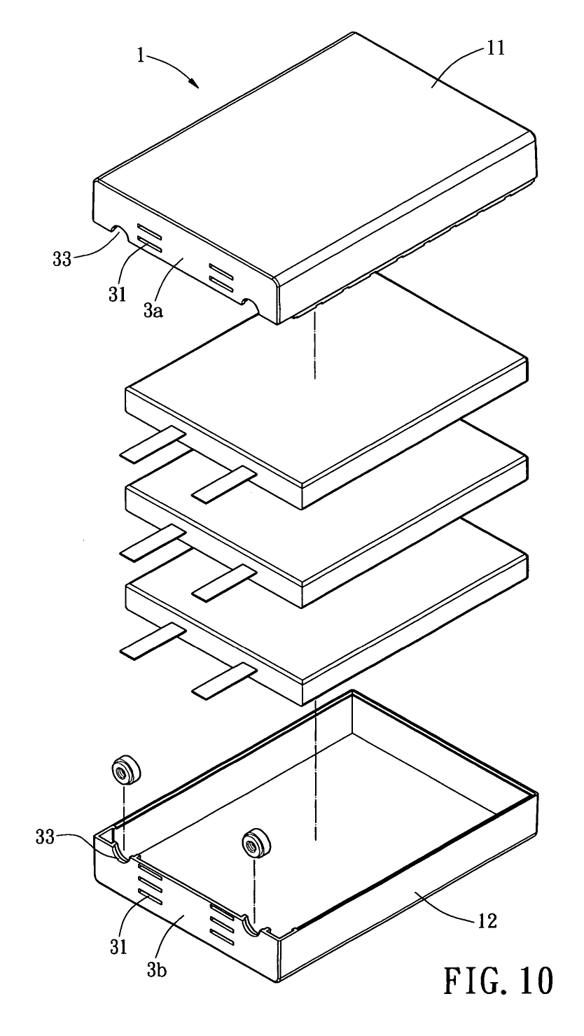

Referring to FIG. 5, FIG. 6, FIG. 7 and FIG. 8, the usage of the battery set, in accordance with the second embodiment of the present invention is illustrated. When the battery set of the present invention is used in different electronic devices, the conducting element 4 of the battery set can be disposed vertically or horizontally in the sagged portion 14. The conducting element 4 and the contact point 32 are electrically connected via the fastening element 41. By incorporating the sagged portion 14 of the chassis 1 and the conducting element 4, the battery set can be used to supply electrical power to different electronic devices.

Referring to FIG. 9, an explosive view in accordance with the third embodiment of the present invention is illustrated. The upper and lower covers 11, 12 of the chassis can each include an opening portion 111, 112, thereby limiting the position of the inserted collector board 3 being between the openings 111, 112. Thus, the collector board 3 is exposed outside of the chassis 1 surface.

Referring to FIG. 10, an explosive view in accordance with the fourth embodiment of the present invention is illustrated. One end of the upper and lower covers 11, 12 of the chassis 1 can be disposed a collector board 3a, 3b, respectively. A notch 33 is formed on the edges of the collector board 3a, 3b adjacent the insertion holes 31. After the upper cover 11 and the lower cover 12 are combined, the contact points 32 are limited between the notches 33.

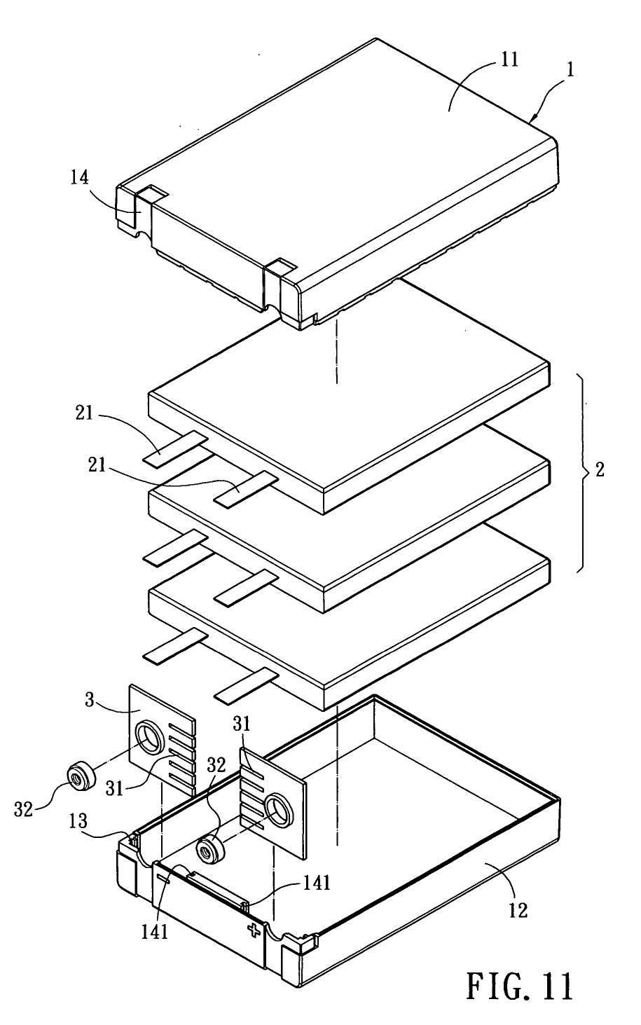

Referring to FIG. 11, an explosive view in accordance with the fifth embodiment of the present invention is illustrated. As shown, the center of the insertion groove 13 of the chassis 1 includes a separator 14 having a corresponding groove 141 disposed thereon. Two collector boards 3 are thus allowed to insert into the insertion groove 13 in the presence of the separator 14. Each collector board 3 includes a plurality of insertion holes 31 correspondingly disposed thereon, thereby allowing the electrodes 21 of the batteries 2 to be inserted into the insertion holes 31 of each collector board 3. The electrodes 21 are then folded to contact with each other, and forming electrical connection with the collector board 3. The contact points 32 can thus define the positive and negative electrodes of the battery set.

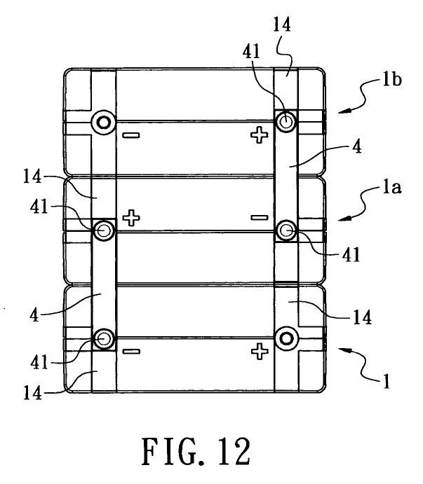

Referring to FIG. 12, an explosive view in accordance with the sixth embodiment of the present invention is illustrated. As shown, a plurality of chassises 1, 1a, 1b can be stacked together to fit the need of different electronic devices. In this particular embodiment, three chassises 1, 1a, 1b are stacked together. The negative electrode of the chassis 1 is electrically connected to the positive electrode of the chassis 1a via the conducting element 4 by incorporating with the sagged portion 14. On the other hand, the negative electrode of the chassis 1a is electrically connected to the positive electrode of the chassis 1b via the conducting element 4 by incorporating with the sagged portion 14. A fastening element 41 is used to electrically connect the conducting element 4 and the contact point 32. By properly arranging the connection of the conducting element 4 on the stacked chassises 1, 1a, 1b, one can adjust the output voltage of the battery set according to the need of any electronic device.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A battery set, comprising:
a chassis;
a collector board disposed in the chassis, comprising a plurality of insertion holes and contact points; and
a plurality of lithium batteries disposed within the chassis, the electrodes of the batteries being inserted in the insertion holes and connected with each other, thereby forming a battery set.

2. The battery set as recited in claim 1, wherein the chassis comprises an upper cover and a lower cover.

3. The battery set as recited in claim 1, wherein the chassis further comprises an insertion groove for inserting thereon the collector board.

4. The battery set as recited in claim 1, wherein the contact points of the collector board includes a positive electrode and a negative electrode of the battery set.

5. A low resistance battery set, comprising:
a chassis, which includes a sagged portion on two side surfaces thereof;
a collector board disposed within the chassis, which includes at least a contact point communicably connecting to the sagged portion;
a plurality of lithium batteries disposed within the chassis, the electrodes of the lithium batteries being connected to the collector board; and
a plurality of conducting elements disposed in the sagged portion, the conducting elements electrically connecting the contact points.

6. The battery set as recited in claim 5, wherein the contact point comprises a fastening hole.

7. The battery set as recited in claim 5, wherein the sagged portion comprises a concave groove communicable along at least three directions.

8. The battery set as recited in claim 5, wherein the conducting element comprises a foldable metallic plate.

9. The battery set as recited in claim 5, wherein the conducting element is fastened to the contact point via a fastening element.

10. A low resistance lithium battery set, comprising:
a chassis having a plurality of through holes and fastening holes formed thereon;
a contact point disposed on the fastening hole; and
a plurality of lithium batteries disposed within the chassis, the electrodes of the batteries being penetrated through the through holes and connected with each other, thereby forming a lithium battery set.
